(19) United States
(12) Patent Application Publication
(10) Pub. No.: US 2003/0231632 A1
(43) Pub. Date: Dec. 18, 2003

(54) Method and system for packet-level routing

(75) Inventor: Andreas Haeberlen, Balingen (DE)

Correspondence Address: William A. Kinnaman, Jr., IBM Corporation - MS P386, 2455 South Road, Poughkeepsie, NY, 12601, US

(73) Assignee: International Business Machines Corporation, Armonk, NY

(21) Appl. No.: 10/456,651

(22) Filed: Jun. 6, 2003

(30) Foreign Application Priority Data
Jun. 13, 2002 (EP) 02013040.7

(51) Int. Cl. H04L 12/28

(52) U.S. Cl. 370/395.5; 370/466

(57) ABSTRACT

According to the present invention a method, device and a computer program product is provided for packet-level routing. The method, the device and the respective computer program product may be used in a computer system being connected to a communications network. The computer system includes a kernel providing a first interface for sending and retrieving data packets to the data link layer, a second interface for sending and retrieving data packets to the network layer, and filtering means for controlling the transportation of data packets to and from the network layer.

### BACKGROUND OF THE INVENTION

1. Field of the Invention

The present invention generally relates to a method and device for packet level routing, particularly, to a method and device for packet-level routing that may be implemented on top of standard interfaces provided by operating systems such as Linux™ or Unix™. More particularly, the present invention relates to a method and device for packet-level routing suitable for running any desired routing protocol, e.g., one to be used by mobile nodes in an ad hoc network.

2. Description of the Related Art

The method and device in accordance with the present invention may be used with a wide variety of computer systems, e.g., enterprise servers, personal computers (PCs), laptop or notebook computers, personal digital assistants (PDAs), and mobile or cellular phones, all being equipped with a connection to a communications network. The connection may either be a physical (i.e., wired) connection or a wireless connection. The network may be any kind of network, such as a local area network (LAN), metropolitan area network (MAN), wide area network WAN), if classified according to their geographical extent, or a BITNET, Ethernet, Internet, or Novell™ network, or even the Ad Hoc On-Demand Distance Vector (AODV) routing network, if classified according to the protocols used.

A suitable computer system is provided with an operating system having kernel-level code and user-level code. The kernel-level code includes all parts of the operating system related to the operating system's kernel.

The kernel is the essential center of a computer operating system, the core that provides basic services for all other parts of the operating system. Typically, a kernel (or any comparable center of an operating system) includes an interrupt handler that handles all requests or completed I/O operations that compete for the kernel's services, a scheduler that determines which programs share the kernel's processing time in what order, and a supervisor that actually gives use of the computer to each process when it is scheduled. A kernel may also include a manager of the operating system's address spaces in memory or storage, sharing these among all components and other users of the kernel's services. A kernel's services are requested by other parts of the operating system or by applications through a specified set of program interfaces sometimes known as system calls.

User-level code refers not only to application-level code, which is considered to run on top of the operating system, but also to devices that may be implemented by computer programs, which influence directly the way the computer system functions. Such devices are considered to be part of the operating system itself. Such code includes parameters whose value influences the kernel's behavior and devices performing basic operations in close cooperation with the kernel-level code.

A suitable operating system to be used in conjunction with the present invention may be the Unix operating system, i.e., a widely used multi-user general-purpose operating system, or a Unix-like operating system, such as the AIX™ operating system from IBM Corporation, or any one of the operating systems A/UX, BSD, Debian, FreeBSD, GNU, HP-UX, Linux, NetBSD, NEXTSTEP, OpenBSD, OPENSTEP, OSF, POSIX, RISCiX, Solaris, SunOS, System V, Ultrix, USG Unix, Version 7, and Xenix. (Trademarks have not been individually indicated in the above listing.) In the following the reference to the Unix operating system shall imply a reference to any one of the Unix-like operating systems or any other operating system that provides the required infrastructure and interfaces as described.

In view of networking, the operating system also provides the functionality of a router, i.e., a device that forwards data packets between networks. The expression “packet” refers to a unit of data sent across a network and is generically used to describe a unit of data at any layer of the OSI (Open Systems Interconnect) Reference Model. The forwarding decision may be based on data link layer information or network layer information, according to the OSI Reference Model, and routing tables, often constructed by routing protocols.

In the Unix operating system ‘routing’ is handled by the kernel. Hence, a change to the routing protocol necessitates modifications to the kernel. Although such modifications may be implemented by a new kernel module, i.e., an independent piece of operating system code which forms part of the operating system's kernel, the new code will run as part of the kernel and may compromise or crash the system if it is malicious or simply buggy. In this context it should be noted that kernel modules are significantly harder to test and debug because they can crash the entire kernel. This usually forces a reboot of the computer system and thus long development cycles. Furthermore, kernel modules are not easy to deploy, because they need to be customized for a particular kernel, e.g., a particular kernel version or a particular kernel of Unix or one of the Unix-like operating systems.

A way to avoid modifications within the kernel could be achieved by modifying the kernel's routing table, e.g., via ioctl( ). However, this approach offers only very limited possibilities and is too coarse-grain for highly dynamic protocols like ad-hoc routing, since changes to the kernel's routing table cannot influence the routing of individual packets.

### SUMMARY OF THE INVENTION

Starting from this, a principal object of the present invention is to provide a method and a system for packet-level routing that allows the implementation of a desired routing protocol with a high level of flexibility.

This and other objects are achieved by a method and a system as laid out in the independent claims. Further advantageous embodiments of the present invention are described in the subclaims and are taught in the following description.

According to the present invention a method, device and a computer program product are provided for packet-level routing. The method, the device and the respective computer program product may be used in a computer system connected to a communications network having a data link layer and a network layer. The computer system includes a kernel providing a first interface for sending data packets to and retrieving them from the data link layer, a second interface for sending data packets to and retrieving them from the network layer, and filtering means for controlling the transportation of data packets to and from the network layer.

The first interface may be formed by any means that are configured to intercept data packets coming from or going to the data link layer. In a Unix environment the first interface may be implemented by using a packet socket. The packet socket connects directly to a network device, such as an Ethernet interface, and does not perform any packet processing. It just captures or delivers the data packets in their raw form, i.e., including the data-link header, e.g., the Ethernet header. From the user-level portion of the operating system the packet socket can be used via system calls, i.e., an application programming interface (API) provided by the kernel.

The data link layer is the second layer of the OSI Reference Model, built onto the physical layer that forms the first layer in the OSI Reference Model. The data link layer provides synchronization for the physical layer and furnishes transmission protocol knowledge and management.

The second interface may be formed by any means that is configured to intercept data packets coming from or going to the network layer. In a Unix environment the second interface may be implemented by using a packet socket as well, cf. the first interface above.

The network layer is built on top of the data link layer and is, therefore, the third layer in the OSI Reference Model. The network layer handles the routing of the data, i.e., sending it in the right direction to the right destination on outgoing transmissions and receiving incoming transmissions at the packet level.

The filtering means may be implemented by any mechanism which is able to filter and/or redirect individual data packets. In a Unix environment this can be accomplished with the commands /sbin/ifconfig, /sbin/route, /sbin/ipchains, /sbin/ipfwadm.

The command “ifconfig” is used to configure the kernel-resident network interfaces. It is used at boot time to set up interfaces as necessary. After that, it is usually only needed when debugging or when system tuning is needed.

The command “route” manipulates the kernel's IP routing tables. Its primary use is to set up static routes to specific hosts or networks via an interface after it has been configured with the “ifconfig” program.

The command “ipchains” is used to set up, maintain, and inspect the IP firewall rules in the Linux kernel. These rules can be divided into four different categories: the IP input chain, the IP output chain, the IP forwarding chain, and user-defined chains. For each of these categories, a separate table of rules is maintained, any of which might refer to one of the user-defined chains.

Ipfwadm-wrapper emulates the behavior of ipfwadm. This wrapper may be used to use old ipfwadm firewall rules with ipchains. If the kernel does not support ipchains (e.g., a Linux 2.0 kernel), and the file /sbin/ipfwadm.real exists and is executable, then it will be executed with the arguments given to ipfwadm-wrapper. This allows simple dual booting of 2.2 and 2.0 kernels with the same firewalling scripts: simply move ipfwadm to ipfwadm.real, and ipfwadm-wrapper to ipfwadm.

According to the present invention the device receives an incoming data packet arriving from the communications network via the first interface. Subsequently, the incoming data packet gets treated according to a particular routing protocol that is implemented in a routing unit formed as part of the device outside the operating system's kernel. Then the incoming data packet gets sent to the second interface to be forwarded to an application program running on the computer system.

The device may be implemented as part of the user-level code of the operating system, e.g., it may be implemented as a daemon (Disk And Execution MONitor). A daemon is a program that is not invoked explicitly, but lies dormant waiting for some condition(s) to occur. The idea is that the perpetrator of the condition need not be aware that a daemon is lurking, though often a program will commit an action only because it knows that it will implicitly invoke a daemon.

Incoming data packets, also referred to as inbound data packets, are such data packets arriving from the communication network via the first interface. Such packets may be forwarded to application programs running on the computer system or they may be routed to other computer systems that may be reached through the communication network.

The routing unit is a functional unit of the device for packet-level routing in accordance with the present invention. The routing unit may be realized as a portion of the daemon forming the device itself. The routing unit implements the desired routing protocol, i.e., the mechanism for selecting the correct interface and next destination for a packet being forwarded.

The application program is a complete, self-contained program that performs a specific function directly for the user. This is in contrast to system software such as the operating system kernel, server processes and libraries that exist to support application programs. Examples of application programs include word processors, database programs, Web browsers, development tools, drawing, paint, and image editing programs, as well as communication programs.

According to a preferred embodiment of the present invention an outgoing data packet arriving from the application program is received by the device via the second interface. Then the outgoing data packet gets treated according to the particular routing protocol implemented in the routing unit, and, subsequently, the outgoing data packet gets sent to the first interface to be forwarded to the communications network.

The outgoing data packets, also referred to as outbound data packets, are such data packets arriving from the application program through the standard protocol stack, in the present scenario a TCP/IP (Transmission Control Protocol over Internet Protocol) stack and via the second interface, whereby the expression “TCP/IP stack” refers to the standard implementation of the OSI layers in a Unix system implementing the TCP/IP protocol. Such packets may be forwarded to the communications network to be transferred to other computer systems that may be reached through the communications network, or they may be routed to other application programs running on the computer system.

Advantageously, the outgoing data packet is transferred to a loopback device provided by the computer system in order to receive the outgoing data packet from the first interface, whereby the loopback device is provided by the computer system and forwards every data packet sent to it to the network layer.

The loopback device is a virtual device that can be used like any other media device, such as a network card or a storage device. The special feature of the loopback in the current context is the fact that it is configured so that all data packets sent to the device are returned and forwarded to the network layer of the standard TCP/IP stack like any ordinary incoming data packets.

In order to avoid that the outgoing data packets sent to that loopback device again enter the network layer and that the outgoing data packets are reversed to the application program, they are blocked from being returned to the network layer by the filtering means provided by the operating system's kernel.

Also the incoming data packet gets transferred to the loopback device to be forwarded to the network layer.

Correspondingly, in order to avoid that the incoming data packet is forwarded from the data link layer to the network layer before being treated by the routing unit, it is blocked by the filtering means.

In a further advantageous embodiment, the device generates a data packet identifier for uniquely identifying each outgoing and incoming data packet and storing the data packet identifier in a duplicate list. Whenever a data packet gets received by the device, it is determined whether or not the data packet is already referred to in the duplicate list, and, if so, the particular data packet gets discarded and the respective identifier gets removed from the duplicate list.

The data packet identifier may be any code or value that allows the unambiguous identification of a single data packet. For this purpose, the entire data packet could be stored. However, in order to save storage space, only a digest value of the data packet may be stored. The digest value could be generated by using a digest function, e.g., a hash function.

The duplicate list may be realized in the volatile memory of the computer system. It is configured to keep the data packet identifier of the packets to be monitored. Alternatively, the duplicates may be handled in a round-robin-replacement fashion, i.e., the entries in the duplicate list are not removed whenever a duplicate was identified, but after a certain time.

In order to perform the functionality as described above, the device for packet-level routing according to the present invention comprises means for receiving an incoming data packet from the first interface arriving from the communications network, means for treating the incoming data packet according to a particular routing protocol implemented in a routing unit formed outside the operating system's kernel, and means for sending the incoming data packet to the second interface to be forwarded to an application program running on the computer system.

Such means may be implemented as software modules, i.e., portions of a program product. They could also be realized in form of one or more hardware units. However, since the method and device in accordance with the present invention is executed on a computer system a software implementation may be preferred.

Furthermore, the device includes means for receiving an outgoing data packet from the second interface arriving from the application program, means for treating the outgoing data packet according to the particular routing protocol implemented in the routing unit, and means for sending the outgoing data packet to the first interface to be forwarded to the communications network.

Moreover the device is provided with means for transferring the incoming data packet to a loopback device to be forwarded to the network layer.

Advantageously, the device according to the present invention is equipped with means for generating a data packet identifier for uniquely identifying each outgoing and incoming data packet, means for storing the data packet identifier in a duplicate list formed in data storage, as well as means for determining whether the data packet is referred to in the duplicate list and means for discarding the data packet and removing the respective identifier from the duplicate list if the data packet is referred to in the duplicate list.

The data storage may be any kind of volatile or non-volatile storage unit present in the computer system, such as the main memory, cache memory or storage devices such as hard drives.

The method, device and computer program product in accordance with the present invention advantageously avoids the necessity to modify the operating system's kernel. Hence, any desired routing protocol may be implemented in user-level code. This greatly simplifies development and testing, which can now be done without endangering the system's stability and security. Furthermore this will increase the customers' acceptance of the new functionality, since customers usually hesitate to load modules into their kernel. When using the method, device or program product as presented here, they will only need to start a daemon and configure the system accordingly and they will advantageously get a system that provides full routing functionality according to any desired routing protocol.

### BRIEF DESCRIPTION OF THE DRAWINGS

The above, as well as additional objectives, features and advantages of the present invention, will be apparent in the following detailed written description.

The novel features of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein:

FIG. 1 is a block diagram illustrating a computer system in which the method, device and computer program product according to the present invention may be implemented;

FIG. 2 is the block diagram of FIG. 1 showing the path of an incoming data packet;

FIG. 3 is the block diagram of FIG. 1 showing the path of an outgoing data packet; and

FIG. 4 shows a flow chart illustrating the method according to the present invention.

### DETAILED DESCRIPTION OF THE INVENTION

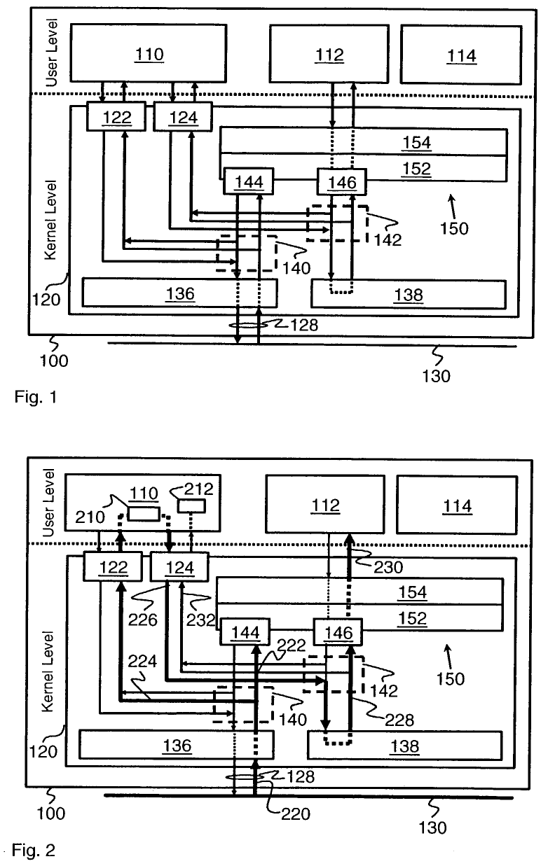

With reference to FIG. 1, there is depicted a block diagram illustrating a computer system 100 in which the method, the device 110 for packet-level routing and a respective computer program product according to the present invention may be implemented. The computer system 100 comprises a plurality of functional units that may be grouped in user-level related functional units and kernel-level related functional units. The different groups are visualized by a dotted line separating from each other the functional groups belonging to each group.

As aforementioned, the user level includes the device 110 for packet-level routing according to the present invention. Furthermore, it includes a first application program 112 and a second application program 114. For the sake of clarity a further differentiation between user-level functional units belonging to the computer system's operating system and functional units belonging to the application level is omitted.

The kernel level comprises the computer system's kernel 120. The kernel provides interfaces to user-level functional units, namely a first interface 122 for sending and retrieving data packets to the data link layer and a second interface 124 for sending and retrieving data packets to the network layer. Furthermore the kernel 120 offers a bidirectional connection 128 to an external communications network 130.

In addition, the kernel 120 includes a network device 136, such as an Ethernet device driver, a loopback device 138, a first packet socket 140, a second packet socket 142, a first filtering means 144, a second filtering means 146, and a TCP/IP stack 150 implementing at least an IP (or network) layer 152 and a TCP (or transport) layer 154.

The first and second packet sockets 140, 142 basically implement the first and second interfaces 122 and 124 respectively provided by the kernel 120.

The solid lines and arrows illustrate the transmission of packets between the functional units in accordance with the present invention. The dotted lines connecting some of the solid lines illustrate that the packets may be manipulated in the respective functional units before being forwarded to the following one.

In the embodiment according to FIG. 1 the device 110 is implemented by a daemon. From the user level, the daemon is only able to access the network through the first and second interfaces 122, 124 provided by the kernel 120, which are implemented by the sockets API (Application Programming Interface). According to the present invention the device 110, i.e., the daemon, handles data packets before they reach the IP stack 150, i.e., right after they come out of the network device 136, thus, directly from the data link layer.

In order to do so, the daemon uses a special kind of socket, the first and second packet socket 140, 142. Unlike ordinary sockets, packet sockets are not connected to the TCP/IP stack 150 but they tap directly into the network device 136 and the loopback device 138, respectively. While active, they copy every data packet that passes through them (inbound or outbound) and deliver it to the daemon unmodified, i.e., including “layer 2” (data link layer) information such as MAC (Media Access Control) addresses. At this point the TCP/IP stack 150 is not involved. In return, the first and second packet sockets 140, 142 also accept data packets from the daemon and pass them directly to the network device 136 and the loopback device 138, respectively.

This way, the daemon can send and receive its own packets, unnoticed by the TCP/IP stack 150. However, incoming packets are still forwarded to the TCP/IP stack 150, where they are processed using standard kernel routing policies. This would interfere with the daemon's own routing policies that are implemented by the daemon and thus need to be prevented with filter rules.

When the daemon decides that an incoming packet should be delivered to the local system, it cannot deliver it directly because the packet still needs to be processed by the TCP/IP stack 150. However, the corresponding interface is internal to the kernel and cannot be accessed from the user level. Thus, the daemon has to use the second interface 124. Via the second interface 124 the daemon transmits incoming data packets into the loopback device 138. From there, the packets are bounced back immediately, but are now considered ‘normal’ incoming packets, i.e., they are fed into the TCP/IP stack 150, as they would come directly from the network device 136. In a similar fashion, outbound packets are routed to the loopback device by the kernel, where they are intercepted by the daemon and forwarded to the network device 136.

If the daemon listens at the loopback device via the second interface 124 through the second packet socket 142, it receives both outbound and inbound data packets twice. Data packets that are thrown into the loopback device 138 are reflected and thus received a second time by the daemon via the second packet socket 142. To avoid processing duplicates, the daemon maintains a hash table for all packets it has received recently and discards duplicates.

Advantageously, according to the present invention, any desired routing protocol may be implemented as a user-level daemon. The concept of the present invention advantageously allows the implementation of the method or daemon in accordance with the present invention on all Unix systems.

First, the first packet socket 140 is opened to the network device 136, e.g., an Ethernet card, implementing the first interface 122. In the following, all data packets are received by the daemon without any manipulation or filtering by any other functional units. Then, a filter rule is activated in the first filtering means provided by the kernel that ignores all incoming packets from the network device 136. From the kernel's point of view the network connectivity is then blocked effectively. The second packet socket 142 is opened to the loopback device 138.

Subsequently, the daemon is able to make a routing decision for every single incoming data packet and, e.g., forward it to another network device (not shown). If the packet is for the local machine, i.e., the computer system 100 itself, the daemon can send it to the loopback device 138, where it is reflected to the TCP/IP stack 150. It has to be noted that for this device the filter rule does not apply, so that the data packets take the normal path through the TCP/IP stack 150 to the first application program 112. Advantageously, the implementation of a new routing protocol in the user level by the usage of a daemon in accordance with the present invention is completely transparent to the application programs, i.e., the application programs do not need any changes to function with any new routing protocol. Outgoing packets are captured from the loopback device 138 in a similar fashion and forwarded to the network if appropriate.

In other words, from the kernel's point of view, all network connectivity is linked to the loopback device 138 and forwarding between TCP/IP stack 150 and the network device 136 is completely handled by the daemon, i.e., the device 110.

Being in complete control of the network connectivity, the daemon can also add, drop, modify, split, merge or reorder packets, or make any other modification that may be required by the protocol or considered advantageous. This is particularly important for wireless networks.

FIG. 2 shows the block diagram of FIG. 1 having visualized the path of an incoming data packet. The path of an incoming data packet is marked with thick arrows and lines. It should be noted that the same reference numbers refer to the same functional units as in FIG. 1. Only the device 110 shows two more details, namely, the routing unit 210 and the duplicate list 212.

An incoming packet arrives from the communications network 130 via the connection 128 to the network device 136. The destination of the incoming data packet is the first application 112. The following steps are taken to process this packet:

The data packet is received by a network interface card (not shown), e.g., an Ethernet card, and is copied into a buffer (not shown) of the corresponding network device 136 (arrow 220).

The data packet's protocol type is evaluated, and the packet is forwarded to the appropriate protocol stack, in the present scenario, the TCP/IP stack 150 (arrow 222). Additionally, it is copied by the first packet socket 140 and delivered to the daemon (device 110) via the first interface 122 (arrow 224).

The first filtering device 144 drops the data packet, i.e., the data packet does not reach the TCP/IP stack 150.

The daemon analyzes the data packet and makes a routing decision according to the routing protocol implemented in the routing unit 210. In the shown case, it is assumed that the data packet is to be delivered to the local system, so the daemon writes the data packet via the second interface 124 to the second packet socket 142 (arrow 226).

The data packet arrives at the loopback device 138, where it is reflected into the TCP/IP stack 150 (arrow 228). The data packet reaches the TCP/IP stack 150 because the second filtering means 146 does not block data packets that are sent to the loopback device 138 by the daemon. Additionally, the data packet is duplicated by second packet socket 142 because it is now considered an inbound packet from the loopback device 138.

The TCP/IP stack 150 processes the packet and delivers data to the first application program 112 (arrow 230).

The daemon receives the duplicate packet (arrow 232) and computes a data packet identifier, such as a hash value. The data packet identifier is compared to the data packet identifiers stored in the duplicate list 212. As the data packet identifier matches a data packet the daemon has sent itself (arrow 226), it discards the duplicate data packet.

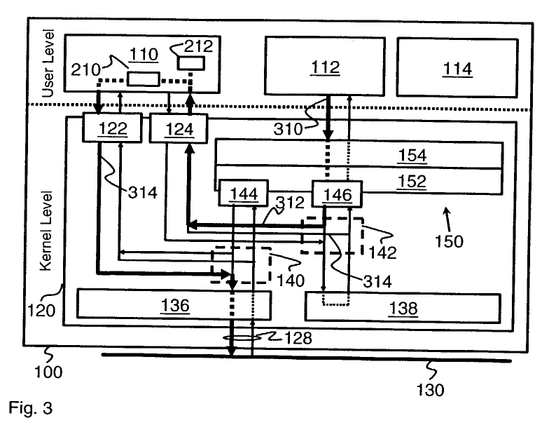

Now with reference to FIG. 3, there is depicted the block diagram of FIG. 1 having visualized the path of an outgoing data packet. The first application program 112 sends an outbound data packet. The following steps are taken to process this data packet:

The data is received by the protocol stack, here the TCP/IP stack 150 (arrow 310).

The kernel consults its routing table (not shown) to determine on which network interface the data packet should be sent. In this case, all traffic is routed to the loopback device 138 so that it can be intercepted by the daemon (the device 110).

The data packet is copied by the second packet socket 142 and gets delivered to the daemon (arrow 312). Additionally, the data packet is delivered to the loopback device 138, where it is reflected. Again, the second packet socket 142 copies the packets, so that the daemon gets the same data packet twice (arrow 314). The daemon, however, detects the duplicate data packet by a comparison with its duplicate list 212, and discards it. The protocol stack 150 does not accept the reflected packets because the second filtering device 146 is configured to block this data packet. It is detected by its network address.

The daemon makes a routing decision. For the following it is assumed that the data packet is to be sent to the network.

The packets are modified by the daemon. This is necessary because, e.g., the kernel has supplied incorrect link layer addresses. The daemon may also change the protocol type and/or add additional headers. The daemon writes the packets back to the first packet socket 140 via the first interface 122, where they are delivered to the corresponding network device 136 (arrow 314). The device driver forwards the packets via the connection 128 to the communications network 130.

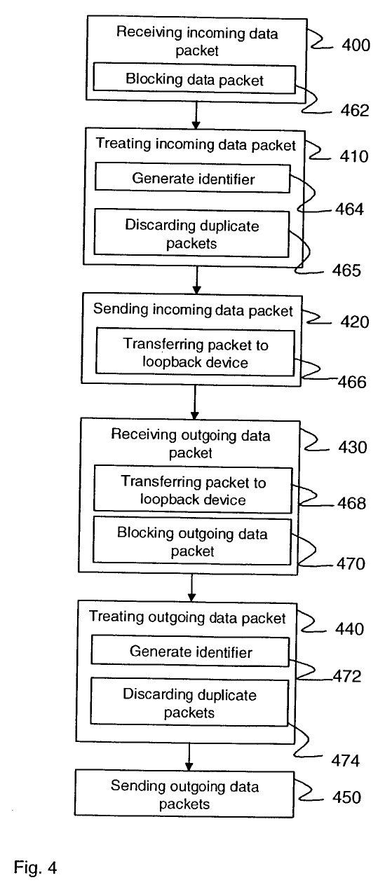

Finally with reference to FIG. 4, there is depicted a flow chart illustrating the method according to the present invention. An incoming data packet is received from the first interface 122 arriving from the communications network 130 (block 400). Then the incoming data packet is treated according to a particular routing protocol implemented in a routing unit 210 formed outside the operating system's kernel 120 (block 410). Subsequently the incoming data packet is sent to the second interface 124 to be forwarded to an application program 112 running on the computer system 100 (block 420).

An outgoing data packet is received from the second interface 124 arriving from the application program 112 (block 430). Then, the outgoing data packet is treated according to the particular routing protocol implemented in the routing unit 210 (block 440). Subsequently, the outgoing data packet is sent to the first interface 122 to be forwarded to the communications network 130 (block 450).

The step of receiving an incoming data packet as shown in block 400 further includes the step of blocking the incoming data packet from being forwarded from the data link layer to the network layer 152 of the standard protocol stack 150 before being treated by the routing unit 210 (block 462).

The step of treating incoming data packets as depicted in block 410 further comprises the steps of generating a data packet identifier for uniquely identifying the incoming data packet and storing the data packet identifier in a duplicate list (block 464). Furthermore it includes the step of determining whether or not the incoming data packet is referred to in the duplicate list, and, if yes, discarding the data packet and removing the respective identifier from the duplicate list (block 465).

The step as depicted in block 420 further includes the step of transferring the incoming data packet to a loopback device 138 to be forwarded to the network layer (block 466).

The step as depicted in block 430 further includes the steps of transferring the outgoing data packet to a loopback device 138 provided by the computer system 100 to be forwarded to the network layer (block 468) and blocking the outgoing data packet from being forwarded from the loopback device 138 to the network layer of the standard protocol stack 152 (block 470).

The step of treating outgoing data packets as depicted in block 440 further comprises the steps of generating a data packet identifier for uniquely identifying the outgoing data packet and storing the data packet identifier in a duplicate list (block 472). Furthermore it includes the step of determining whether or not the outgoing data packet is referred to in the duplicate list, and, if yes, discarding the data packet and removing the respective identifier from the duplicate list (block 472).

The mechanism to apply several filter rules to block the IP stack completely against incoming and outgoing traffic can be expressed in other words: For all networks, which shall be routed by the daemon, a route is defined to an alias of the loopback device and all incoming packets the destination of which are those networks are blocked, e.g. by using ipfwadm (Deactivate IP Forwarding).

As an example, this may be done with the following commands. The examples assume a local IP address of 192.168.1.1:

Define an alias for the loopback device:

/sbin/ifconfig lo:0 192.168.1.1 mtu 1500 netmask 255.255.255.255 up

Define an alias (lo:0) for the loopback device. A network interface can have multiple aliases, which are mapped to different IP addresses. In this case, the loopback device is configured for IP address 192.168.1.1 with a maximum packet size of, e.g., 1500 bytes (Ethernet and wireless-LAN) and a netmask of 255.255.255.255, i.e., the subnet contains only one single address. The parameter “up” activates the alias.

Route all packets to the loopback device:

/sbin/route add −net 192.168.1.0 netmask 255.255.255.0 dev lo

This statement defines a route, which forwards all traffic having the destination of the 192.168.1.xxx subnet to the loopback device.

Suppress forwarding of packets between internal interfaces:

/sbin/ipchains −P forward DENY

The command “ipchains” implements the packet filter of Linux 2.2. The functionality is also supported by 2.4-systems. The command defines, that all packets, which shall be forwarded from one internal device to another, are discarded.

Block traffic with filtering means 144:

/sbin/ipfwadm −I−a deny −P all −S 0/0 −D 0/0 −W eth0

/sbin/ipfwadm −O−a deny −P all −S 0/0 −D 0/0 −W eth0

These commands finally activate the filter. Normally, the command “ipfwadm” is used for administering firewalls. Basically, all packets arriving from (−I) or destined to (−O) the Ethernet device (eth0) are discarded (‘deny’ policy) regardless of the source address (0, 0 bits relevant) and the destination address (0, also 0 bits relevant). Note that this filtering means only affect the protocol stack, i.e., the packet sockets can still send and receive packets from the Ethernet device.

The present invention can be realized in hardware, software, or a combination of hardware and software. Any kind of computer system or other apparatus adapted for carrying out the methods described herein is suited. A typical combination of hardware and software could be a general-purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

What is claimed is:

1. A method for packet-level routing in a computer system connected to a communications network having a data link layer and a network layer, the computer system having an operating system kernel providing a first interface for sending data packets to and retrieving them from the data link layer, a second interface for sending data packets to and retrieving them from the network layer, and filtering means for controlling transportation of data packets to and from the network layer, the method comprising the steps of:
receiving an incoming data packet from the first interface arriving from the communications network;
treating the incoming data packet according to a particular routing protocol implemented in a routing unit formed outside the operating system kernel; and
sending the incoming data packet to the second interface to be forwarded to an application program running on the computer system.

2. The method according to claim 1, wherein the step of sending the incoming data packet to the second interface includes the step of:
transferring the incoming data packet to a loopback device to be forwarded to the network layer.

3. The method according to claim 1, wherein the step of receiving an incoming data packet from the first interface includes the step of:
blocking the incoming data packet from being forwarded from the data link layer to the network layer of a standard protocol stack before being treated by the routing unit.

4. The method according to claim 1, further comprising the steps of:
receiving an outgoing data packet from the second interface arriving from the application program;
treating the outgoing data packet according to the particular routing protocol implemented in the routing unit; and
sending the outgoing data packet to the first interface to be forwarded to the communications network.

5. The method according to claim 4, wherein the step of receiving the outgoing data packet from the second interface includes the step of:
transferring the outgoing data packet to a loopback device provided by the computer system to be forwarded to the network layer.

6. The method according to claim 5, wherein the step of receiving the outgoing data packet from the second interface further includes the step of:
blocking the outgoing data packet from being forwarded from the loopback device to the network layer of a standard protocol stack.

7. The method according to claim 4, wherein the step of treating outgoing data packets includes the steps of:
generating a data packet identifier for uniquely identifying the outgoing data packet, and
storing the data packet identifier in a duplicate list.

8. The method according to claim 7, wherein the step of treating outgoing data packets further includes the steps of:
determining whether the outgoing data packet is referred to in the duplicate list; and
if the outgoing data packet is referred to in the duplicate list, discarding the data packet and removing the respective identifier from the duplicate list.

9. A computer program product stored on a computer usable medium, comprising computer readable program means for causing a computer to perform a method according to any one of the preceding claims 1 to 8.

10. A device for packet-level routing in a computer system connected to a communications network having a data link layer and a network layer, the computer system having an operating system kernel providing a first interface for sending data packets to and retrieving them from the data link layer, a second interface for sending data packets to and retrieving them from the network layer, and filtering means for controlling the transportation of data packets to and from the network layer, the device comprising:
means for receiving an incoming data packet from the first interface arriving from the communications network;
means for treating the incoming data packet according to a particular routing protocol implemented in a routing unit formed outside the operating system kernel; and
means for sending the incoming data packet to the second interface to be forwarded to an application program running on the computer system.

11. The device according to claim 10, wherein the means for sending the incoming data packet to the second interface includes:
means for transferring the incoming data packet to a loopback device to be forwarded to the network layer.

12. The device according to claim 10, further comprising:
means for receiving an outgoing data packet from the second interface arriving from the application program;
means for treating the outgoing data packet according to the particular routing protocol implemented in the routing unit; and
means for sending the outgoing data packet to the first interface to be forwarded to the communications network.

13. The device according to claim 12, wherein the means for treating the outgoing data packet includes:
means for generating a data packet identifier for uniquely identifying the outgoing data packet; and
means for storing the data packet identifier in a duplicate list formed in data storage.

14. The device according to claim 13, wherein the means for treating the outgoing data packet further includes:
means for determining whether the outgoing data packet is referred to in the duplicate list; and
means for discarding the data packet and removing the respective identifier from the duplicate list if the outgoing data packet is referred to in the duplicate list.
